(19) United States
(12) Patent Application Publication
(10) Pub. No.: US 2026/0302041 A1
(43) Pub. Date: Oct. 1, 2026

(54) COIL COMPONENT

(71) Applicant: TDK Corporation, Tokyo (JP)

(72) Inventors: Ryuji HASHIMOTO, Tokyo (JP); Nobuyuki OKUZAWA, Tokyo (JP); Koki ENDO, Tokyo (JP); Kenshin KURUMAI, Tokyo (JP)

(73) Assignee: TDK Corporation, Tokyo (JP)

(21) Appl. No.: 19/630,621

(22) Filed: Mar. 27, 2026

(30) Foreign Application Priority Data
Mar. 31, 2025 (JP) 2025-058160

(51) Int. Cl. H01F 27/28; H01F 27/29; H01F 27/32

(52) U.S. Cl. CPC H01F 27/2804; H01F 27/292; H01F 27/323; H01F 27/327

(57) ABSTRACT

A coil component includes: an element body having a mounting surface and a main surface facing the mounting surface; a pair of terminal electrodes disposed on the mounting surface of the element body; and a coil disposed in the element body and electrically connected to the pair of terminal electrodes, wherein the coil includes a first wiring part disposed on the main surface side, a second wiring part disposed on the mounting surface side, and a connection part extending in an opposing direction of the mounting surface and the main surface and connecting the first wiring part and the second wiring part, the connection part is constituted by a plurality of connection members arranged in the opposing direction, and a boundary between one connection member and another connection member adjacent to each other is offset from a central position of the connection part in the opposing direction.

### CROSS-REFERENCE TO RELATED APPLICATIONS

This application is based upon and claims the benefit of priority from Japanese Patent Application No. 2025-058160, filed on 31 March, 2025, the entire content of which is incorporated herein by reference.

### TECHNICAL FIELD

The present disclosure relates to a coil component.

### BACKGROUND

Japanese Unexamined Patent Publication No. 2023-104202 discloses a coil component including: an element body having a pair of end surfaces facing each other in a first direction, a mounting surface and a main surface facing each other in a second direction, and a pair of side surfaces facing each other in a third direction; a pair of terminal electrodes disposed on the mounting surface of the element body; and a coil disposed in the element body and electrically connected to the pair of terminal electrodes, wherein the coil includes a plurality of first wiring parts disposed on a main surface side and arranged side by side in the third direction, a plurality of second wiring parts disposed on a mounting surface side and arranged side by side in the third direction, and a plurality of connection parts extending in the second direction and connecting corresponding first wiring parts and second wiring parts.

### SUMMARY

A coil component according to one aspect of the present disclosure includes: an element body having a mounting surface and a main surface facing the mounting surface; a pair of terminal electrodes disposed on the mounting surface of the element body; and a coil disposed in the element body and electrically connected to the pair of terminal electrodes, wherein the coil includes a first wiring part disposed on a main surface side, a second wiring part disposed on a mounting surface side, and a connection part extending in an opposing direction of the mounting surface and the main surface and connecting the first wiring part and the second wiring part, the connection part is constituted by a plurality of connection members arranged in the opposing direction, and a boundary between one connection member and another connection member adjacent to each other is offset from a central position of the connection part in the opposing direction.

### BRIEF DESCRIPTION OF THE DRAWINGS

FIG. 1 is a perspective view of a coil component according to an embodiment.

FIG. 2 is a view of the coil component illustrated in FIG. 1 as viewed from an end surface side.

FIG. 3 is a view showing a configuration of a pillar part.

FIG. 4 is a view schematically showing a shape of a pillar member of the pillar part.

### DETAILED DESCRIPTION

### Problems to be Solved by the Present Disclosure

In a coil component, a connection part is constituted by a plurality of connection members. The plurality of connection members are arranged so as to be stacked in an extending direction of the connection part. Stress is applied to the connection part connecting a first wiring part and a second wiring part from each of the first wiring part and the second wiring part. These stresses can be most concentrated at a central position in the extending direction of the connection part in the connection part. In this case, if a boundary (connection interface) where two connection members contact each other is located at the central position of the connection part, there is a possibility that strength of the connection part decreases at the boundary portion.

An object of one aspect of the present disclosure is to provide a coil component capable of suppressing a decrease in strength of a connection part of a coil.

### Effects of Present Disclosure

According to one aspect of the present disclosure, it is possible to suppress a decrease in strength of a connection part of a coil.

### Description of Embodiments of Present Disclosure

First, contents of embodiments of the present disclosure will be listed and described. At least some of the embodiments described below may be arbitrarily combined.
(1) A coil component according to one aspect of the present disclosure includes: an element body having a mounting surface and a main surface facing the mounting surface; a pair of terminal electrodes disposed on the mounting surface of the element body; and a coil disposed in the element body and electrically connected to the pair of terminal electrodes, wherein the coil includes a first wiring part disposed on the main surface side, a second wiring part disposed on the mounting surface side, and a connection part extending in an opposing direction of the mounting surface and the main surface and connecting the first wiring part and the second wiring part, the connection part is constituted by a plurality of connection members arranged in the opposing direction, and a boundary between one connection member and another connection member adjacent to each other is offset from a central position of the connection part in the opposing direction.

In the coil component according to one aspect of the present disclosure, the connection part is constituted by the plurality of connection members arranged in the opposing direction. In this configuration, the boundary between one connection member and another connection member adjacent to each other in the coil component is offset from the central position of the connection part in the opposing direction. Thereby, even when stress is applied to the connection part in the coil component, since the boundary of the connection members is not located at the central position where the stress is most concentrated, the stress does not concentrate on the boundary. Therefore, it is possible to suppress a decrease in strength of the connection part of the coil in the coil component. As a result, it is possible to suppress occurrence of displacement or the like at the boundary between the two connection members due to stress in the coil component, and thus it is possible to achieve stabilization of the structure of the connection part. Therefore, it is possible to suppress a decrease in reliability in the coil component.
(2) In the coil component of the above (1), at least two of the plurality of connection members may have different lengths in the opposing direction. In this configuration, by including the connection members having different lengths in the connection part, it is possible to offset the boundary between the connection members from the central position.
(3) In the coil component of the above (2), of the plurality of connection members having different lengths in the opposing direction, long connection members may be disposed closer to the main surface side than short connection members. Since the first wiring part is disposed on the main surface side facing the mounting surface on which the terminal electrodes are disposed, it is difficult to release heat in a circuit board or the like on which the coil component is mounted. Thereby, thermal stress due to thermal expansion can increase in the first wiring part. Therefore, the boundary of the connection part is preferably located at a position away from the first wiring part in order to make it difficult to be affected by the thermal stress. In the above configuration, since the long connection member is disposed closer to the main surface side than the short connection member, it is possible to locate the boundary of the connection part at a position away from the first wiring part.
(4) In the coil component of any one of the above (1) to (3), each of the plurality of connection members has a first face and a second face facing each other in the opposing direction, areas of the first face and the second face are different, and the second face of one connection member and the first face of another connection member adjacent to each other may be disposed to face each other. In this configuration, even if a position of the other connection member is offset with respect to the one connection member, since the areas of the first face and the second face are different, one face can fit within the other face. Therefore, it is possible to secure a contact area between the one connection member and the other connection member. Thus, even when displacement occurs in arrangement (stacking) of the one connection member and the other connection member in the coil component, it is possible to secure a certain amount of contact area (it is possible to reduce a variation amount of the contact area). Therefore, it is possible to suppress occurrence of variation in the contact area in which the one connection member and the other connection member are in contact in the coil component. As a result, it is possible to suppress occurrence of variation in characteristics in the coil component.
(5) In the coil component of any one of the above (1) to (4), the connection part may be constituted by four connection members.
(6) In the coil component of the above (4), of the four connection members, lengths in the opposing direction of two connection members disposed on the main surface side may be equal, and lengths in the opposing direction of two connection members disposed on the mounting surface side may be equal.
(7) In the coil component of the above (6), the lengths in the opposing direction of the two connection members disposed on the main surface side may be longer than the lengths in the opposing direction of the two connection members disposed on the mounting surface side.
(8) In the coil component of any one of the above (1) to (7), each of the plurality of connection members may exhibit a conical frustum shape.
(9) In the coil component of the above (1), each of the plurality of connection members has a first face and a second face facing each other in the opposing direction, and an area of the first face on the main surface side may be larger than an area of the second face on the mounting surface side.
(10) In the coil component of the above (9), the area of the first face of each of the plurality of connection members may be equal to each other.
(11) In the coil component of any one of the above (1) to (10), the element body exhibits a rectangular parallelepiped shape, and may have the pair of main surfaces and mounting surface facing each other in the opposing direction, a pair of end surfaces facing each other in a first direction orthogonal to the opposing direction, and a pair of side surfaces facing each other in a third direction orthogonal to the opposing direction and the first direction.
(12) In the coil component of the above (11), a coil axis of the coil may be provided along the third direction which is an opposing direction of the pair of side surfaces.
(13) In the coil component of any one of the above (1) to (12), the coil has a plurality of the first wiring parts, a plurality of the second wiring parts, and a plurality of the connection parts, and the number of the plurality of second wiring parts may be one less than the number of the plurality of first wiring parts.
(14) In the coil component of the above (11), the first wiring part extends along the first direction which is an opposing direction of the pair of end surfaces, and the second wiring part may extend along the first direction.
(15) In the coil component of any one of the above (1) to (14), the pair of terminal electrodes includes a first terminal electrode and a second terminal electrode, and the coil component may further include a first connection conductor connecting the first terminal electrode and one end portion of the coil, and a second connection conductor connecting the second terminal electrode and another end portion of the coil.
(16) In the coil component of any one of the above (1) to (15), the pair of terminal electrodes is embedded in the element body, and a surface of each of the pair of terminal electrodes may be flush with the mounting surface.
(17) In the coil component of any one of the above (1) to (16), the element body is formed by laminating a plurality of element body layers in the opposing direction, and the element body layer may be a resin layer.
(18) In the coil component of any one of the above (1) to (17), all boundaries between adjacent connection members in the connection part may be offset from the central position of the connection part in the opposing direction.
(19) In the coil component of the above (11), the connection part may be disposed on one end surface side of the pair of end surfaces of the element body.
(20) In the coil component of the above (11), the first wiring part, the second wiring part, and the connection part may be disposed apart from the pair of end surfaces, the pair of main surfaces, and the pair of side surfaces of the element body.

### Details of Embodiments of Present Disclosure

Specific examples of embodiments of the present disclosure will be described below with reference to the drawings. The present disclosure is not limited to these examples, but is indicated by the claims, and is intended to include all modifications within the meaning and scope equivalent to the claims. In the description of the drawings, the same elements are denoted by the same reference numerals, and redundant description thereof will be omitted.

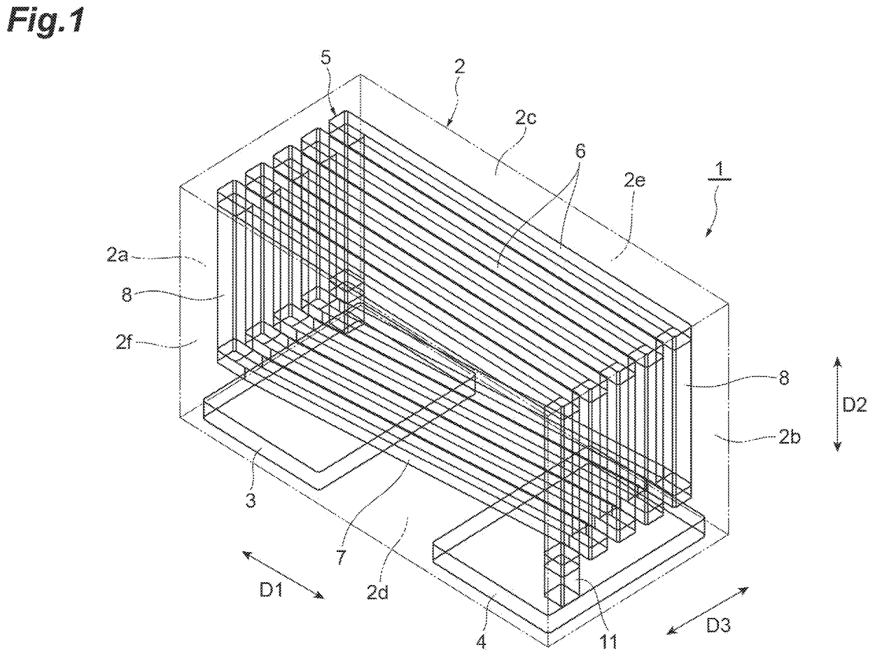

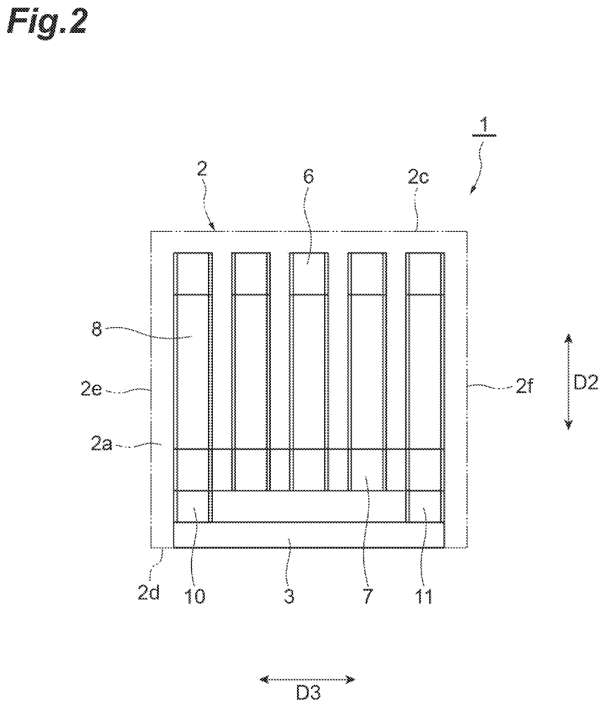

A coil component according to the present embodiment will be described with reference to FIG. 1. FIG. 1 is a perspective view of a coil component according to an embodiment. As illustrated in FIG. 1, a coil component 1 includes an element body 2, a first terminal electrode 3 and a second terminal electrode 4, a coil 5, and a first connection conductor 10 (see FIG. 2) and a second connection conductor 11. In FIGS. 1 and 2, the element body 2 is indicated by a two-dot chain line. In FIG. 1, the coil 5 is illustrated transparently.

The element body 2 exhibits a rectangular parallelepiped shape. The rectangular parallelepiped shape includes a rectangular parallelepiped shape in which corner portions and ridge line portions are chamfered, and a rectangular parallelepiped shape in which corner portions and ridge line portions are rounded. The element body 2 has, as outer surfaces, a pair of end surfaces 2a and 2b, a pair of main surfaces 2c and 2d, and a pair of side surfaces 2e and 2f. The end surfaces 2a and 2b face each other. The main surfaces 2c and 2d face each other. The side surfaces 2e and 2f face each other. Hereinafter, an opposing direction of the end surfaces 2a and 2b is referred to as a first direction D1, an opposing direction of the main surfaces 2c and 2d is referred to as a second direction D2, and an opposing direction of the side surfaces 2e and 2f is referred to as a third direction D3. The first direction D1, the second direction D2, and the third direction D3 are substantially orthogonal to each other.

The end surfaces 2a and 2b extend in the second direction D2 so as to connect the main surfaces 2c and 2d. The end surfaces 2a and 2b also extend in the third direction D3 so as to connect the side surfaces 2e and 2f. The main surfaces 2c and 2d extend in the first direction D1 so as to connect the end surfaces 2a and 2b. The main surfaces 2c and 2d also extend in the third direction D3 so as to connect the side surfaces 2e and 2f. The side surfaces 2e and 2f extend in the first direction D1 so as to connect the end surfaces 2a and 2b. The side surfaces 2e and 2f also extend in the second direction D2 so as to connect the main surfaces 2c and 2d.

The main surface 2d is a mounting surface, and is, for example, a surface facing another electronic device when mounting the coil component 1 on the other electronic device (for example, a circuit substrate or a coil component) (not illustrated). The end surfaces 2a and 2b are surfaces continuous from the mounting surface (that is, the main surface 2d).

In the case of the form illustrated in FIGS. 1 and 2, a length of the element body 2 in the first direction D1 is longer than a length of the element body 2 in the second direction D2 and a length of the element body 2 in the third direction D3. The length of the element body 2 in the second direction D2 is shorter than the length of the element body 2 in the third direction D3. That is, in the present embodiment, the end surfaces 2a and 2b, the main surfaces 2c and 2d, and the side surfaces 2e and 2f exhibit a rectangular shape. The length of the element body 2 in the second direction D2 may be equal to the length of the element body 2 in the third direction D3, or may be longer than the length of the element body 2 in the third direction D3.

In the present embodiment, “equal” may mean not only being equal but also a value including a minute difference or a manufacturing error in a preset range. For example, if a plurality of values are included within a range of ±1.5% of an average value of the plurality of values, the plurality of values are defined as being equal.

The element body 2 is formed by laminating a plurality of element body layers (insulating layers) in the second direction D2. That is, a laminating direction of the element body 2 is the second direction D2. In the actual element body 2, the plurality of element body layers may be integrated to such an extent that boundaries between the layers cannot be visually recognized, or may be integrated such that the boundaries between the layers can be visually recognized.

The element body layer may be, for example, a resin layer. A material of the element body layer includes, for example, at least one selected from a liquid crystal polymer, a polyimide resin, crystalline polystyrene, an epoxy resin, an acrylic resin, a bismaleimide-based resin, and a fluorine-based resin. The element body layer may contain a filler. The filler may be, for example, an inorganic filler. Examples of the inorganic filler include silica (SiO₂). Note that the element body layer may not contain a filler.

Note that the element body layer may be configured to contain a magnetic material. The magnetic material of the element body layer includes, for example, a Ni—Cu—Zn-based ferrite material, a Ni—Cu—Zn—Mg-based ferrite material, or a Ni—Cu-based ferrite material. The magnetic material of the element body layer may contain, for example, an Fe alloy. The element body layer may contain, for example, a non-magnetic material. The non-magnetic material of the element body layer includes, for example, a glass ceramic material or a dielectric material.

Each of the first terminal electrode 3 and the second terminal electrode 4 is provided in the element body 2. Each of the first terminal electrode 3 and the second terminal electrode 4 is disposed on the main surface 2d of the element body 2. The first terminal electrode 3 and the second terminal electrode 4 are provided in the element body 2 so as to be separated from each other in the first direction D1. Specifically, the first terminal electrode 3 is disposed on the end surface 2a side of the element body 2. The second terminal electrode 4 is disposed on the end surface 2b side of the element body 2.

Each of the first terminal electrode 3 and the second terminal electrode 4 may exhibit, for example, a rectangular shape. Each of the first terminal electrode 3 and the second terminal electrode 4 is disposed such that each side is along the first direction D1 or the third direction D3. As illustrated in FIG. 2, the first terminal electrode 3 and the second terminal electrode 4 are embedded in the element body 2. The first terminal electrode 3 and the second terminal electrode 4 do not protrude from the main surface 2d. In the present embodiment, a surface of each of the first terminal electrode 3 and the second terminal electrode 4 is flush with the main surface 2d. The first terminal electrode 3 and the second terminal electrode 4 are constituted by a conductive material (for example, Cu).

A plating layer (not illustrated) containing, for example, Ni, Sn, Au, or the like may be provided on each of the first terminal electrode 3 and the second terminal electrode 4 by performing electrolytic plating or electroless plating. The plating layer may have, for example, a Ni plating film containing Ni and covering the first terminal electrode 3 and the second terminal electrode 4, and an Au plating film containing Au and covering the Ni plating film.

As illustrated in FIGS. 1 and 2, the coil 5 is disposed in the element body 2. The coil 5 has a plurality of first wiring parts 6, a plurality of second wiring parts 7, and a plurality of pillar parts (connection parts) 8. The coil 5 is constituted by electrically connecting the first wiring parts 6, the second wiring parts 7, and the pillar parts 8. A coil axis of the coil 5 is provided along the third direction D3. The plurality of first wiring parts 6, the plurality of second wiring parts 7, and the plurality of pillar parts 8 are constituted by a conductive material (for example, Cu). The first wiring parts 6, the second wiring parts 7, and the pillar parts 8 are disposed apart from the end surfaces 2a and 2b, the main surfaces 2c and 2d, and the side surfaces 2e and 2f.

Each of the first wiring parts 6 is disposed on the main surface 2c side of the element body 2. Each of the first wiring parts 6 extends along the first direction D1. Each of the first wiring parts 6 connects two pillar parts 8. The first wiring part 6 is bridged between two pillar parts 8. One end portion (end portion on the end surface 2a side) in an extending direction of the first wiring part 6 is connected to one end portion (end portion on the main surface 2c side) of the pillar part 8. The other end portion (end portion on the end surface 2b side) in the extending direction of the first wiring part 6 is connected to one end portion (end portion on the main surface 2c side) of the pillar part 8.

Each of the second wiring parts 7 is disposed on the main surface 2d (mounting surface) side of the element body 2. Each of the second wiring parts 7 extends in the first direction D1. Each of the second wiring parts 7 connects two pillar parts 8. The second wiring part 7 is bridged between two pillar parts 8. One end portion (end portion on the end surface 2a side) in an extending direction of the second wiring part 7 is connected to the other end portion (end portion on the main surface 2d side) of the pillar part 8. The other end portion (end portion on the end surface 2b side) in the extending direction of the second wiring part 7 is connected to the other end portion (end portion on the main surface 2d side) of the pillar part 8. The number of the plurality of second wiring parts 7 is one less than the number of the plurality of first wiring parts 6. That is, when the number of the first wiring parts 6 is n, the number of the second wiring parts 7 is n−1.

Each of the plurality of pillar parts 8 is disposed on the end surface 2a side or the end surface 2b side of the element body 2. Each of the plurality of pillar parts 8 extends along the second direction D2. The pillar part 8 connects the first wiring part 6 and the second wiring part 7. One end portion of the pillar part 8 is connected to one end portion of the first wiring part 6. The other end portion of the pillar part 8 is connected to one end portion of the second wiring part 7.

The first connection conductor 10 connects the first terminal electrode 3 and one end portion of the coil 5. The first connection conductor 10 is connected to the other end portion of the pillar part 8 of the coil 5. The first connection conductor 10 is disposed at a position closer to the end surface 2a and closer to the side surface 2e. The first connection conductor 10 is constituted by a conductive material. The first connection conductor 10 is formed of, for example, Cu.

The second connection conductor 11 connects the second terminal electrode 4 and the other end portion of the coil 5. The second connection conductor 11 is connected to the other end portion of the pillar part 8 of the coil 5. The second connection conductor 11 is disposed at a position closer to the end surface 2b and closer to the side surface 2f. The second connection conductor 11 is constituted by a conductive material. The second connection conductor 11 is formed of, for example, Cu.

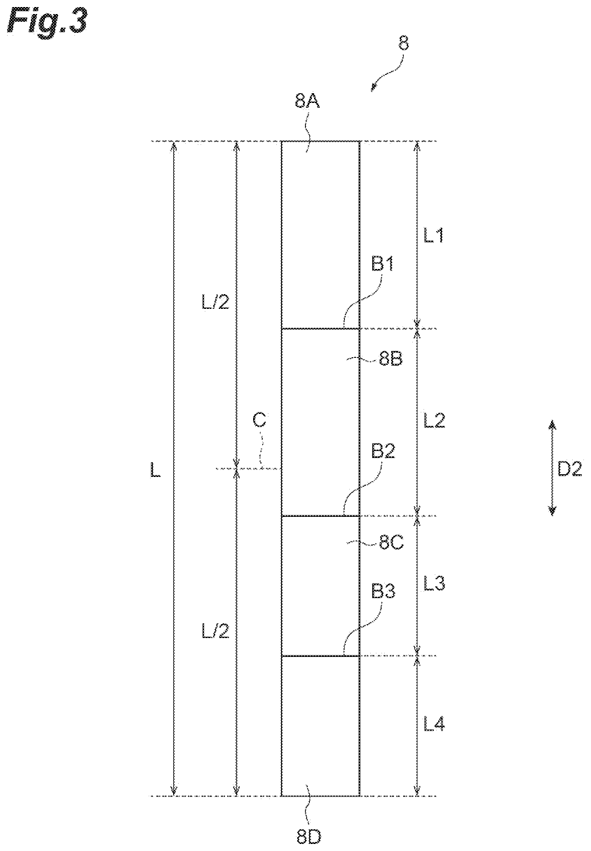

Subsequently, the pillar part 8 will be described in detail. FIG. 3 is a view showing a configuration of the pillar part 8. As illustrated in FIG. 3, the pillar part 8 is constituted by a plurality of pillar members (connection members). In the present embodiment, the pillar part 8 is constituted by four pillar members 8A, 8B, 8C, and 8D. The four pillar members 8A, 8B, 8C, and 8D are arranged (stacked) in the second direction D2. In the present embodiment, the pillar member 8D, the pillar member 8C, the pillar member 8B, and the pillar member 8A are arranged in this order from the main surface 2d side of the element body 2. In other words, the pillar member 8A, the pillar member 8B, the pillar member 8C, and the pillar member 8D are arranged in this order from the main surface 2c side of the element body 2.

Each of the four pillar members 8A, 8B, 8C, and 8D extends in the second direction D2. In the present embodiment, a length L1 of the pillar member 8A in the second direction D2 and a length L2 of the pillar member 8B in the second direction D2 are equal (L1=L2). A length L3 of the pillar member 8C in the second direction D2 and a length L4 of the pillar member 8D in the second direction D2 are equal (L3=L4). In the present embodiment, the length L1 of the pillar member 8A and the length L2 of the pillar member 8B are different in length from the length L3 of the pillar member 8C and the length L4 of the pillar member 8D. The length L1 of the pillar member 8A and the length L2 of the pillar member 8B are longer than the length L3 of the pillar member 8C and the length L4 of the pillar member 8D (L1, L2>L3, L4).

In the present embodiment, the length L1 of the pillar member 8A and the length L2 of the pillar member 8B are, for example, 35 μm. The length L3 of the pillar member 8C and the length L4 of the pillar member 8D are, for example, 25 μm.

In the pillar part 8, the pillar member 8A and the pillar member 8B having a long length in the second direction D2 are disposed closer to the main surface 2c side of the element body 2 than the pillar member 8C and the pillar member 8D having a short length. In the pillar part 8, the pillar member 8C and the pillar member 8D having a short length in the second direction D2 are disposed closer to the main surface 2d side than the pillar member 8A and the pillar member 8B having a long length.

In the pillar part 8, each boundary (connection interface) of the pillar members 8A, 8B, 8C, and 8D is offset from a central position C of the pillar part 8 in the second direction D2. The central position C is a position of ½ of a length L (L1+L2+L3+L4) of the pillar part 8 in the second direction D2. That is, the central position C is a position of L/2 from each end of the pillar part 8 in the second direction D2. In the present embodiment, a boundary B1 between the pillar member 8A and the pillar member 8B, a boundary B2 between the pillar member 8B and the pillar member 8C, and a boundary B3 between the pillar member 8C and the pillar member 8D are offset from the central position C of the pillar part 8 in the second direction D2. The boundary B1 is located closer to the main surface 2c side of the element body 2 than the central position C. The boundaries B2 and B3 are located closer to the main surface 2d side of the element body 2 than the central position C. The boundary B1 can also be said to be a seam between the pillar member 8A and the pillar member 8B. The boundary B2 can also be said to be a seam between the pillar member 8B and the pillar member 8C. The boundary B3 can also be said to be a seam between the pillar member 8C and the pillar member 8D.

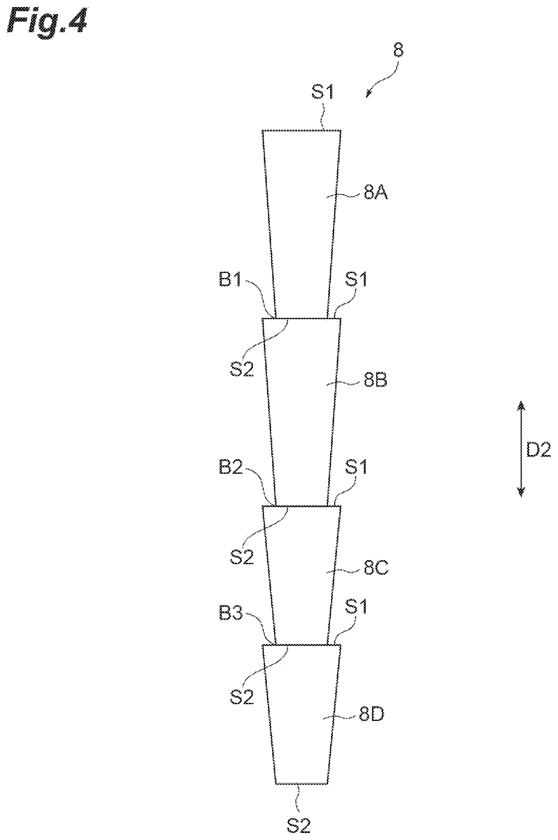

FIG. 4 is a view schematically showing shapes of the pillar members 8A, 8B, 8C, and 8D of the pillar part 8. As illustrated in FIG. 4, each of the pillar members 8A, 8B, 8C, and 8D exhibits a trapezoidal shape when viewed from the third direction D3 (first direction D1). Each of the pillar members 8A, 8B, 8C, and 8D exhibits a conical frustum shape. Each of the pillar members 8A, 8B, 8C, and 8D has a first face S1 and a second face S2 facing each other in the second direction D2. The first face S1 and the second face S2 are different in area. In the present embodiment, an area of the first face S1 on the main surface 2c side of the element body 2 in each of the pillar members 8A, 8B, 8C, and 8D is larger than an area of the second face S2 on the main surface 2d side. In the present embodiment, the area of the second face S2 of the pillar member 8C and the area of the second face S2 of the pillar member 8D are larger than the area of the second face S2 of the pillar member 8A and the area of the second face S2 of the pillar member 8D. The areas of the first faces S1 of the pillar members 8A, 8B, 8C, and 8D are equal.

The second face S2 of the pillar member 8A faces the first face S1 of the pillar member 8B. The boundary B1 is formed by the second face S2 of the pillar member 8A and the first face S1 of the pillar member 8B. The second face S2 of the pillar member 8B faces the first face S1 of the pillar member 8C. The boundary B2 is formed by the second face S2 of the pillar member 8B and the first face S1 of the pillar member 8C. The second face S2 of the pillar member 8C faces the first face S1 of the pillar member 8D. The boundary B3 is formed by the second face S2 of the pillar member 8C and the first face S1 of the pillar member 8D.

As described above, in the coil component 1 according to the present embodiment, the pillar part 8 is constituted by the plurality of pillar members 8A, 8B, 8C, and 8D arranged in the second direction D2. In this configuration, the boundary B1 between the pillar member 8A and the pillar member 8B, the boundary B2 between the pillar member 8B and the pillar member 8C, and the boundary B3 between the pillar member 8C and the pillar member 8D in the coil component 1 are offset from the central position C of the pillar part 8 in the second direction D2. Accordingly, even when stress is applied to the pillar part 8 in the coil component 1, the boundaries B1, B2, and B3 are not located at the central position C where the stress is most concentrated, and thus the stress does not concentrate on the boundaries B1, B2, and B3. Therefore, it is possible to suppress a decrease in strength of the pillar part 8 of the coil 5 in the coil component 1. As a result, it is possible to suppress occurrence of displacement or the like at the boundaries B1, B2, and B3 due to stress in the coil component 1, and thus it is possible to achieve stabilization of the structure of the pillar part 8. Therefore, it is possible to suppress a decrease in reliability in the coil component 1.

In the coil component 1 according to the present embodiment, of the plurality of pillar members 8A, 8B, 8C, and 8D, the pillar members 8A and 8B and the pillar members 8C and 8D are different in length in the second direction D2. In this configuration, by including the plurality of pillar members 8A, 8B, 8C, and 8D having different lengths in the pillar part 8, it is possible to displace the boundaries B1, B2, and B3 between the plurality of pillar members 8A, 8B, 8C, and 8D from the central position C.

In the coil component 1 according to the present embodiment, of the plurality of pillar members 8A, 8B, 8C, and 8D, the pillar members 8A and 8B having a long length are disposed closer to the main surface 2c side of the element body 2 than the pillar members 8C and 8D having a short length. Since the first wiring part 6 is disposed on the main surface 2c side facing the main surface 2d of the element body 2 on which the first terminal electrode 3 and the second terminal electrode 4 are disposed, it is difficult to release heat in a circuit board or the like on which the coil component 1 is mounted. Thereby, thermal stress due to thermal expansion can increase in the first wiring part 6. Therefore, the boundary of the pillar part 8 is preferably located at a position away from the first wiring part 6 in order to make it difficult to be affected by the thermal stress. In the above configuration, since the pillar members 8A and 8B having a long length are disposed closer to the main surface 2c side of the element body 2 than the pillar members 8C and 8D having a short length, it is possible to locate the boundary B1 of the pillar part 8 at a position away from the first wiring part 6.

In the coil component 1 according to the present embodiment, each of the plurality of pillar members 8A, 8B, 8C, and 8D has the first face S1 and the second face S2 facing each other in the second direction D2. The first face S1 and the second face S2 are different in area. In the coil component 1, the second face S2 of one adjacent pillar member and the first face S1 of another pillar member are disposed to face each other. In this configuration, even if a position of the other pillar member is offset with respect to the one pillar member, the areas of the first face S1 and the second face S2 are different, and thus one face can fit within the other face. Therefore, it is possible to secure a contact area between the one pillar member and the other pillar member. Thus, in the coil component 1, even when displacement occurs in arrangement (stacking) of the one pillar member and the other pillar member, it is possible to secure a certain amount of contact area (it is possible to reduce a variation amount of the contact area). Therefore, it is possible to suppress occurrence of variation in the contact area in which the one pillar member and the other pillar member are in contact in the coil component 1. As a result, it is possible to suppress occurrence of variation in characteristics in the coil component 1.

Although the embodiment of the present invention has been described above, the present invention is not necessarily limited to the above-described embodiment, and various modifications can be made without departing from the gist thereof.

In the above embodiment, a form in which the pillar part 8 is constituted by the four pillar members 8A, 8B, 8C, and 8D has been described as an example. However, the pillar part 8 may include at least two pillar members.

In the above embodiment, a form in which the pillar members 8A and 8B having a long length are disposed closer to the main surface 2c side of the element body 2 than the pillar members 8C and 8D having a short length has been described as an example. However, the pillar members 8C and 8D having a short length may be disposed closer to the main surface 2c side of the element body 2 than the pillar members 8A and 8B having a long length.

In the above embodiment, a form in which each of the four pillar members 8A, 8B, 8C, and 8D exhibits a trapezoidal shape has been described as an example. However, each of the four pillar members 8A, 8B, 8C, and 8D may have another shape.

In the above embodiment, a form in which the surface of each of the first terminal electrode 3 and the second terminal electrode 4 is flush with the main surface 2d has been described as an example. However, the surface of each of the first terminal electrode 3 and the second terminal electrode 4 may protrude from the main surface 2d.

What is claimed is:

1. A coil component comprising:
an element body formed by laminating a plurality of insulating layers and having a mounting surface and a main surface facing the mounting surface;
a pair of terminal electrodes disposed on the mounting surface of the element body; and
a coil disposed in the element body and electrically connected to the pair of terminal electrodes, wherein
the coil includes a first wiring part disposed on the main surface side, a second wiring part disposed on the mounting surface side, and a connection part extending in an opposing direction of the mounting surface and the main surface and connecting the first wiring part and the second wiring part,
the connection part is constituted by a plurality of connection members arranged in the opposing direction, and
a boundary between one connection member and another connection member adjacent to each other is offset from a central position of the connection part in the opposing direction.

2. The coil component according to claim 1, wherein at least two of the plurality of connection members are different in length in the opposing direction.

3. The coil component according to claim 2, wherein, of the plurality of connection members having different lengths in the opposing direction, connection members having a long length are disposed closer to the main surface side than connection members having a short length.

4. The coil component according to claim 1, wherein
each of the plurality of connection members has a first face and a second face facing each other in the opposing direction,
the first face and the second face are different in area, and
the second face of one connection member and the first face of another connection member adjacent to each other are disposed to face each other.

5. The coil component according to claim 1, wherein the connection part is constituted by four connection members.

6. The coil component according to claim 5, wherein, of the four connection members, lengths in the opposing direction of two connection members disposed on the main surface side are equal, and lengths in the opposing direction of two connection members disposed on the mounting surface side are equal.

7. The coil component according to claim 6, wherein the lengths in the opposing direction of the two connection members disposed on the main surface side are longer than the lengths in the opposing direction of the two connection members disposed on the mounting surface side.

8. The coil component according to claim 1, wherein each of the plurality of connection members exhibits a conical frustum shape.

9. The coil component according to claim 1, wherein
each of the plurality of connection members has a first face and a second face facing each other in the opposing direction, and
an area of the first face on the main surface side is larger than an area of the second face on the mounting surface side.

10. The coil component according to claim 9, wherein the area of the first face of each of the plurality of connection members is equal to each other.

11. The coil component according to claim 1, wherein the element body exhibits a rectangular parallelepiped shape, and has the main surface and the mounting surface facing each other in the opposing direction, a pair of end surfaces facing each other in a first direction orthogonal to the opposing direction, and a pair of side surfaces facing each other in a third direction orthogonal to the opposing direction and the first direction.

12. The coil component according to claim 11, wherein a coil axis of the coil is provided along the third direction which is an opposing direction of the pair of side surfaces.

13. The coil component according to claim 1, wherein
the coil has a plurality of the first wiring parts, a plurality of the second wiring parts, and a plurality of the connection parts, and
the number of the plurality of second wiring parts is one less than the number of the plurality of first wiring parts.

14. The coil component according to claim 11, wherein the first wiring part and the second wiring part extend along the first direction.

15. The coil component according to claim 1, wherein
the pair of terminal electrodes includes a first terminal electrode and a second terminal electrode, and
the coil component further comprises:
a first connection conductor connecting the first terminal electrode and one end portion of the coil; and
a second connection conductor connecting the second terminal electrode and another end portion of the coil.

16. The coil component according to claim 1, wherein
the pair of terminal electrodes is embedded in the element body, and
a surface of each of the pair of terminal electrodes is flush with the mounting surface.

17. The coil component according to claim 1, wherein
the element body is formed by laminating a plurality of element body layers in the opposing direction, and
the element body layer is a resin layer.

18. The coil component according to claim 1, wherein all boundaries between adjacent connection members in the connection part are offset from the central position of the connection part in the opposing direction.

19. The coil component according to claim 11, wherein the connection part is disposed on one end surface side of the pair of end surfaces of the element body.

20. The coil component according to claim 11, wherein the first wiring part, the second wiring part, and the connection part are disposed apart from the pair of end surfaces, the pair of main surfaces, and the pair of side surfaces of the element body.
